(19) United States
(12) Patent Application Publication
(10) Pub. No.: US 2009/0157819 A1
(43) Pub. Date: Jun. 18, 2009

(54) LIVE CONNECTION OF EMAIL THREADS TO DISCUSSION FORUM

(76) Inventor: Mark Carl Hampton, (US)

Correspondence Address: IBM AUSTIN IPLAW (DG), C/O DELIZIO GILLIAM, PLLC, 15201 MASON ROAD, SUITE 1000-312, CYPRESS, TX, 77433, US

(21) Appl. No.: 11/955,015

(22) Filed: Dec. 12, 2007

(51) Int. Cl. G06F 15/16

(52) U.S. Cl. 709/206; 709/218

(57) ABSTRACT

A method, apparatus and program product are provided for making a live connection between an email thread and a discussion forum thread. An email plug-in receives a nomination of an email thread for conversion to a discussion forum thread. The plug-in copies the emails in the email thread as a discussion forum thread with a set of replies as discussion forum messages, where the thread and messages comprising details from the emails. The plug-in then sends the discussion forum thread and messages to a discussion forum server.

### FIELD OF THE INVENTION

The invention relates to the field of computers and more particularly to method, apparatus, and program product for making a live connection between an email thread and a discussion forum thread.

### BACKGROUND

Discussions are often started in an email thread, by exchanging a series of email messages between two or more email users. For a variety of reasons it is sometimes preferable to conduct such discussions on a discussion forum. These reasons, which may not always be apparent when the discussion begins, may include, for example, allowing for participation of a wider audience, promoting visibility and transparency, and providing an archive of discussion after it has concluded.

Currently, if a discussion is switched from email to a discussion forum, a new discussion forum thread is started. Thus, previous exchanges by email are not visible on the discussion forum. Moreover, contributions made via email which did not post prior to the switch may be missed.

### SUMMARY

A method, apparatus and program product are provided for making a live connection between an email thread and a discussion forum thread. An email plug-in receives a nomination of an email thread for conversion to a discussion forum thread. The plug-in copies the emails in the email thread as a discussion forum thread with a set of replies as discussion forum messages, where the thread and messages comprising details from the emails. The plug-in then sends the discussion forum thread and messages to a discussion forum server.

In an exemplary embodiment, new emails replying to the converted thread are also converted into discussion forum replies and forwarded to the discussion forum server. In another embodiment, discussion forum replies to the converted thread may be converted into emails and sent to an email server for routing to a participant in the original email thread or other email user who does not have access to the discussion forum. These embodiments may also be provided concurrently.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of a computer apparatus for making a live connection between an email thread and a discussion forum thread according to an exemplary embodiment of the present invention;

FIG. 2 is a block diagram showing conversion of an email thread to a discussion forum according to an exemplary embodiment of the present invention;

FIG. 3 is a block diagram showing conversion of an email message in a previously converted thread to a discussion forum message and being adding the message to the discussion forum thread according to an exemplary embodiment of the present invention;

FIG. 4 is a block diagram showing conversion of a discussion forum message in a previously converted thread to an email and sending the email to an email user who has elected to participate in the discussion forum via email according to an exemplary embodiment of the present invention;

FIG. 5 is a flow diagram of a method for converting an email thread to a discussion forum according to an exemplary embodiment of the present invention;

FIG. 6 is a flow diagram of a method for converting an email message in a previously converted thread to a discussion forum message and adding the message to the discussion forum thread according to an exemplary embodiment of the present invention

FIG. 7 is a flow diagram of a method for converting a discussion forum message in a previously converted thread being to an email and sending the email to an email user who has elected to participate in the discussion forum via email according to an exemplary embodiment of the present invention.

### DETAILED DESCRIPTION

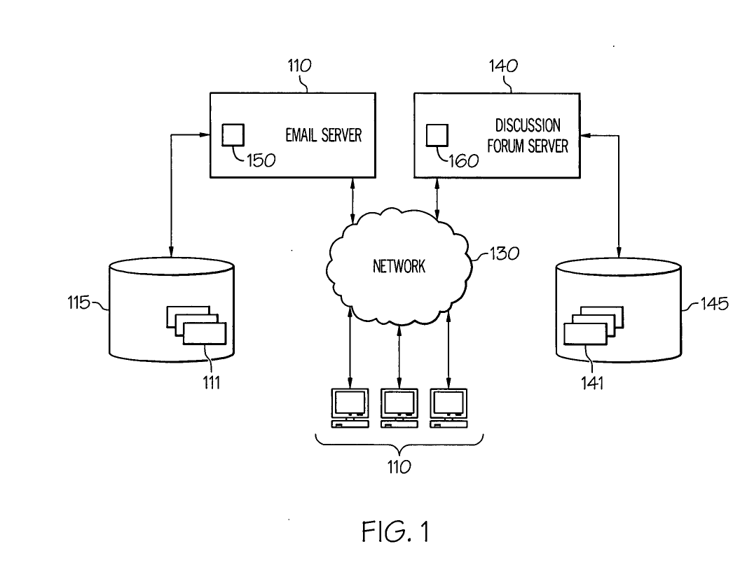

The present invention provides a method, apparatus and program product for making a live connection between an email thread and a discussion forum thread. In an exemplary embodiment, as shown in FIG. 1, a plurality of user computing devices 110 are interconnected to an email server 120 through a network 130. The user computing devices 110 may be, for example, any combination of personal computers (PCs), laptops, personal digital assistants (PDAs), terminals, or any other computing device which may be interconnected to an email server through a network. The email server 120 may comprise any server technology, including, for example, a blade server, dedicated PC, AS400, etc. The network 130 may comprise the Internet, an intranet, a Local Area Network, or any other type of network through which computing devices may be interconnected with a server.

One or more of the plurality of computing devices 110 are also interconnected to a discussion forum server 140. The computing devices 110 may be interconnected with the discussion forum server through the network 130 which interconnects to the email server or through a separate network (not shown) which may be any type of network suitable for interconnection of computing devices and a server.

The email server 120 comprises logic for processing email messages 121 such that they are routed to addressees. In addition to routing, the logic also exposes certain properties and settings such as date, author, subject, and status (e.g., reply, etc). The email server 120 further comprises data storage 115, where messages 111 are stored. In an exemplary embodiment, the email server logic provides threading, whereby a message and all subsequent responses (such as reply, forward, etc) are grouped in a tree structure. The messages which are grouped in a thread may be identified by the original message or topic.

The discussion forum server 140 comprises logic for processing messages 141 posted to initiate or respond to a discussion topic. The messages are typically presented as a thread containing the initial message (sometimes referred to as the thread itself) and all replies to the initial message or any previous reply. The initial message is the parent, and responding messages are children. Messages in a discussion forum may be identified by a unique identifier, as well as the identifier of its parent thread.

A plug-in 150 is provided on the email server 120 for converting email threads 111 to discussion forum messages 141 and sending the newly converted discussion forum messages 141 to the discussion forum server 140. The plug-in 150 may comprise firmware, software, or a combination thereof. The logic may be written in C++, java, or any other programming language suitable for manipulating data.

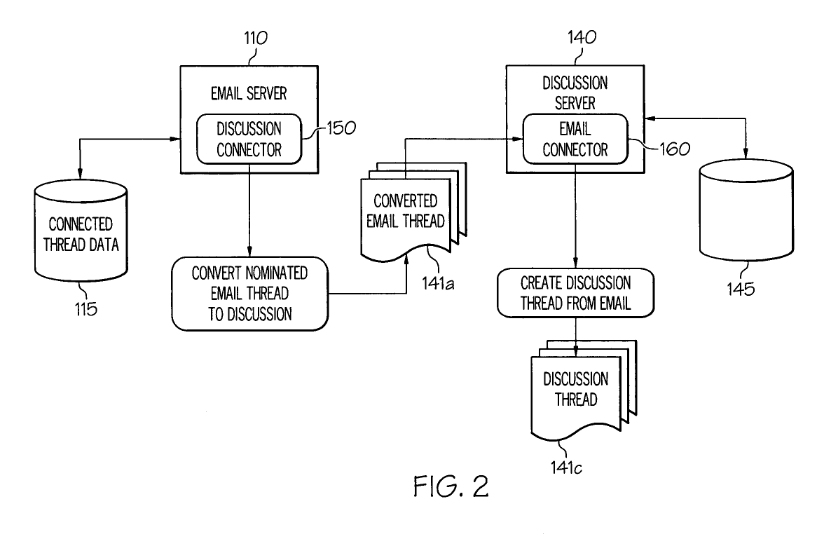

As shown in FIG. 2, the email server plug-in 150 converts a nominated email thread 111 to a discussion forum thread 141a, and sends the converted thread to the discussion forum server 140. The email server plug-in 150 creates a new discussion forum topic in an appropriate sub forum. The first email in the thread becomes the content of this topic—i.e. the body of the email is copied into the body of the discussion topic, the email sender's name is copied into the discussion topic user field, the date of the is copied into the body of the topic to avoid causing the discussion thread to be treated as an old topic. The email plug-in 150 decides which sub forum to store the topic in, typically by asking the user that decided to convert the email thread into a discussion forum thread. Alternatively, (such as when the conversion is done automatically), configuration rules could be used instead to decide the sub forum.

The discussion forum server 140 then adds the converted thread 141a to the discussion forum. In an exemplary embodiment the subject of the initial thread is used as the discussion thread topic. Any system user with access to the chosen discussion forum can then view the converted discussion forum thread 141a on the discussion forum server 140 as though the thread were created in the discussion forum.

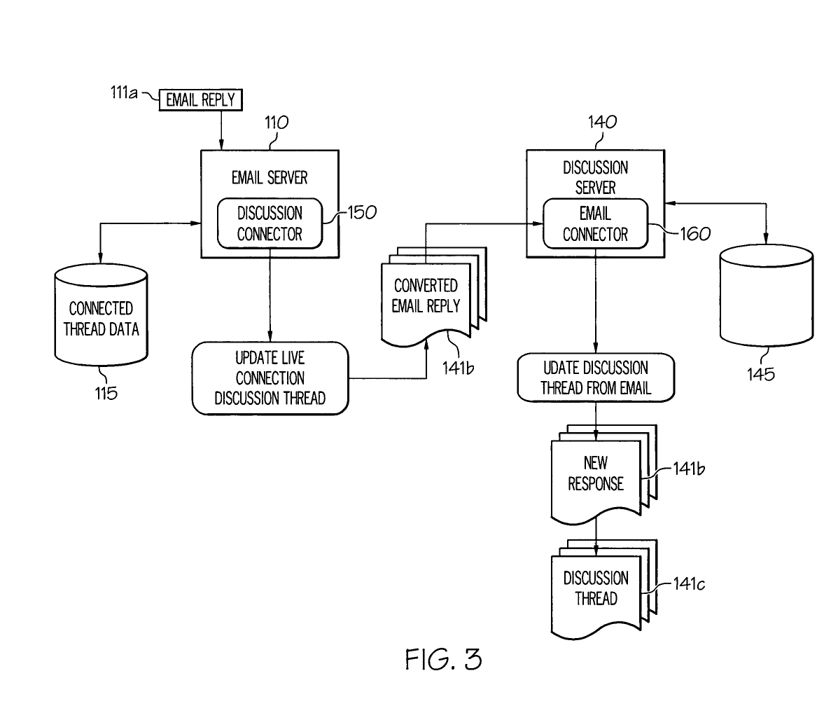

In an exemplary embodiment, shown in FIG. 3, the email server plug-in 150 continues to provide a live connection between the email server 110 and the discussion forum server 140 after the email thread 111 is converted to a discussion forum thread 141a. In this live connection, the converted thread 141a is assigned a unique identifier. A globally unique identifier is generated using any suitable algorithm. This unique identifier is then associated with the converted thread.

When an additional email reply 111a is received by the email server 110 after the email thread 111 is converted to a discussion forum thread 141a, the email server plug-in 150 converts the email reply 111a to a discussion forum message 141b. Then, the email server plug in 150 associates the unique thread identifier with the converted message 141b, and sends the converted message 141b with the identifier to the discussion forum server 140. The discussion forum server then updates the discussion thread 141a with the converted message 141b to create an updated discussion thread 141c.

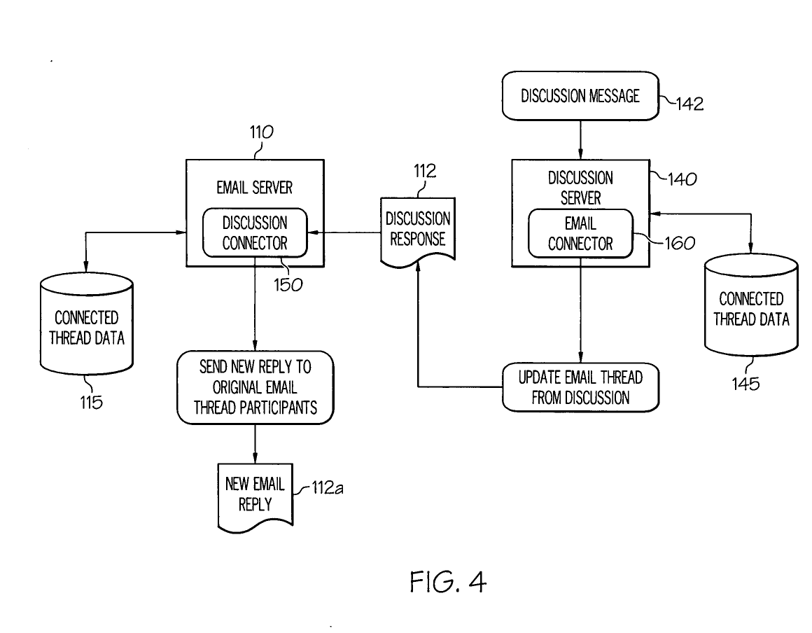

In an exemplary embodiment, as shown in FIG. 4, a discussion forum message 142 is posted to a converted discussion forum thread 141a. A discussion forum server plug-in 160 checks the unique identifier for the converted discussion forum thread 141a. If the unique identifier indicates that there is an email participant in the converted discussion forum thread 141a, then the discussion forum server plug-in 160 converts the new message 142 to an email 112 and sends it to the email server 110 for posting to the email participant's email folder. It should be understood that while the present embodiment is directed to a converted discussion forum thread, a participant could be added to any discussion forum thread by invoking the discussion forum server plug-in 160 and assigning a unique identifier to the thread.

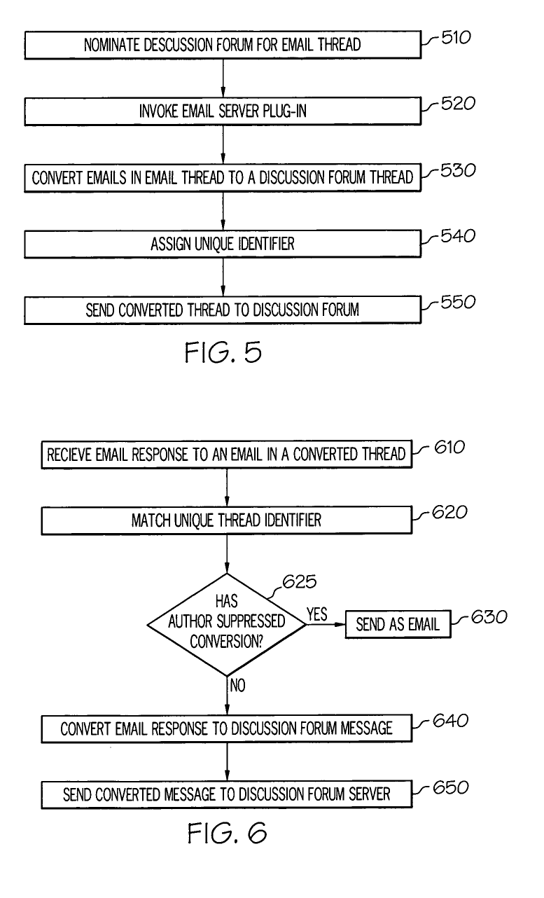

A method for converting an email thread to a discussion forum according to an exemplary embodiment of the present invention is shown in FIG. 5. The method begins when a discussion forum is nominated for an email thread (step 310). The nomination step may be performed by any participant in an email exchange or an administrator. Alternatively, each participant in an email exchange may be required to consent to converting the email thread to a discussion forum.

The nominating step may be performed at a user interface in an email session, for example, by hovering over an email message header and selecting “convert to discussion forum” from a menu of functions. In an exemplary embodiment, the email server plug-in 140 is automatically invoked (step 520) when the conversion option is selected. Alternatively, the email user may invoke the email server plug-in 140 by making a menu selection, or issuing a command, or the like. In an exemplary embodiment, the email server plug-in 140 is invoked after all required consents are received to convert the email thread to a discussion forum thread.

When the email server plug-in 140 is invoked, it converts emails in the identified email thread 111 to a discussion forum thread 141a. The first email is copied into a new “forum topic”, and then each additional email is copied into a “topic reply” for the new topic. These are submitted to the forum using whatever API is available. It is important how attributes are mapped from the email to the discussion. A default mapping might typically use the author of the email as the author of the topic or reply, the subject of the email as the subject of the topic or reply and the body of the email as the body of the topic or reply. However, the plug-in could be configured to map these attributes differently to cater to differences in installations. Also, the time of the email should not be used as the time of the forum topic or reply as this would result in the discussion topic appearing old, which might prevent it from appearing in a list of currently active topics. Attributes (properties and settings) such as author of the email, subject line, etc are extracted from the email for use in the presentation of the converted messages on the discussion forum.

Once the email server plug-in 140 has converted the email thread to a discussion forum thread, it assigns a unique identifier (step 540) to the nominated email thread. This identifier is also assigned to the discussion forum thread, if a live connection is to be maintained. The identifier may be a java long number, a file path for the initial email, or any other identification that is unique for the email thread. Each reply message is also assigned the unique identifier for the thread.

The email server plug-in 140 then sends the converted thread 141a to the nominated discussion forum server 140. The converted thread 141a may be sent over a network using some form of remote messaging—e.g. RMI, HTTP, etc.

In an exemplary embodiment, a live connection is maintained for the converted thread 141a. As shown in FIG. 6, a new email reply 111a is sent in the email thread 111 after the email thread 111 has been converted to a discussion forum thread 141a. The new email reply is associated with the unique identifier that identifies the converted thread. The email system can track the relationship of replies to an email thread. When the email plug-in 150 finds new replies to a thread that has been converted to a discussion thread, it can then associate this new email with the unique identifier previously assigned to the thread. The email plug-in 150 receives the new email reply 111a (step 610). Then, the email plug-in 150 matches the unique identifier associated with the new email reply 111a to the unique identifier for the converted thread 141a Step 620).

After the unique identifier of the new email reply 111a is matched to the unique identifier for the converted thread 141a, the email server plug-in 150 determines whether the author of the new email reply 111a has suppressed conversion of the author's email responses for the current converted thread (step 625). In an exemplary embodiment, when the email thread is converted a user setting allows the email user to suppress conversion of emails to a discussion forum. Thus, the email user may participate in the converted discussion without broadcasting his/her responses to the entire discussion forum community. This feature allows for selective privacy for sensitive information and the like. The suppression function maybe activated from the user interface, for example, as a menu function or any other means for activating a function within an email session. The suppression function may be selectable for all emails, for all emails in a specific thread, or for a specific email.

If email conversion has been suppressed (the yes branch from step 625), then the email server plug-in stops and the new email reply 111a is sent to the addressees as a normal email (step 630).

If email conversion is not suppressed, then the email server plug-in 150 converts the new email reply 111a to a discussion forum message 141b (step 640). The converted message 141b is assigned the unique identifier of the converted thread 141a. As with the messages in the email thread that were originally converted, the email server plug-in 150 extracts attributes and text from the email reply 111a and formats it as a discussion forum message 141b. Now that a discussion forum exists, the new replies that get sent to the discussion forum van be given the same date/time as the emails. This is because they are now always going to be more current (i.e., newer) and so will not effect the currency of the discussion thread.

The email server plug-in sends the converted message 141b to the discussion forum server 140 (step 650). The converted message 141b is sent in a similar way to the emails in the originally converted thread, but it will be a different type of message—i.e. as an update rather than creation of a new thread. Then, the discussion forum server updates the converted thread 141a to include the converted message 141b, resulting in an updated discussion forum thread 141c including the email reply 111a sent after the email thread 111 was converted to a discussion forum thread 141a. Thus, a live connection from the email server to the discussion forum server is maintained, and discussion forum participants can view the converted discussion forum message 141b on the discussion forum.

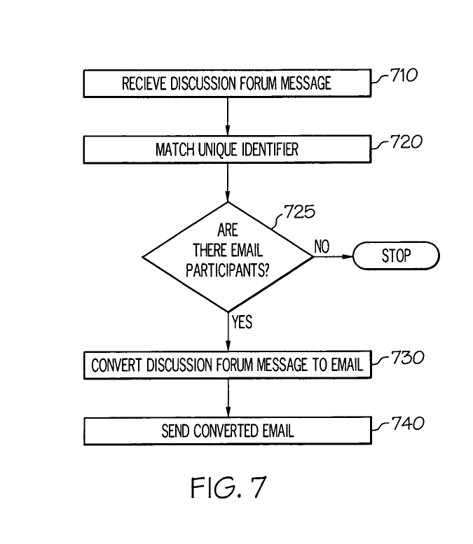

In an exemplary embodiment, a live connection is maintained from the discussion forum back to email participants for the converted thread 141a. A discussion forum participant posts a response 142 to the converted thread 141a. As shown in FIG. 7, the discussion forum server plug-in 160, receives the new discussion forum message 142 (step 710). That is, when the message posts on the discussion forum 140, the discussion forum server plug-in 160 is invoked. The discussion forum server plug-in may be invoked by a system call or by any other means for running a plug-in.

The discussion forum plug-in 160 matches the unique identifier for the converted thread 141a (step 720). That is, the discussion forum plug-in 160 extracts the unique identifier that is assigned to the converted thread and either extracts setting information or looks up setting information from a setting table. The discussion forum pug-in 160 determines whether there are any email participants to the discussion forum thread (step 725) from the acquired settings.

If there are not any email participants for the converted discussion forum thread, then the discussion forum server plug-in stops and the message is only posted on the discussion forum (no branch for step 725). However, if there are email participants, the discussion forum server plug-in 160 converts the new discussion forum message 142 to an email message 112 (step 730). That is, the discussion forum server plug-in 160 extracts attribute data and message text, attachments, embedded graphics, etc from the new discussion forum message 142. Then the discussion forum server plug-in builds an email message 112 in email form using the attributes and text, attachments, embedded graphics and any other content.

The discussion forum server plug-in 160 sends the converted email 112 to the email server 110 (step 740) where it is routed to the email address of the email participant in the discussion forum. Thus, a computing device user who does not have access to the discussion forum or does not choose to use the discussion forum can still view the messages posted on the discussion forum via email.

In various embodiments, one way live connection from the email server to the discussion forum server, one way live connection from the discussion forum server to the email server, or a two way live connection between the email server and the discussion forum server may be maintained.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system or device. For the purposes of this description, a computer-usable or computer readable medium may be any apparatus that can contain, store, communicate, propagate, or transport the program for use by or in connection with the instruction execution system, apparatus, or device.

The foregoing method may be realized by a program product comprising a machine-readable media having a machine-executable program of instructions, which when executed by a machine, such as a computer, performs the steps of the method. This program product may be stored on any of a variety of known machine-readable media, including but not limited to compact discs, floppy discs, USB memory devices, and the like. Moreover, the program product may be in the form of a machine readable transmission. Such as blue ray, HTML, XML, or the like.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The preceding description and accompanying drawing are intended to be illustrative and not limiting of the invention. The scope of the invention is intended to encompass equivalent variations and configurations to the full extent of the following claims.

What is claimed is:

1. A method for making a live connection between an email thread and a discussion forum thread, comprising the steps of:
receiving a nomination of an email thread for conversion to a discussion forum thread;
copying the emails in the email thread as a discussion forum thread with a set of replies as discussion forum messages, the thread and messages comprising details from the emails; and
sending the discussion forum thread and messages to a discussion forum server.

2. The method of claim 1, further comprising the steps of:
assigning a unique identifier to the discussion forum thread; and
in response to a new email reply in the converted thread copying said email reply as a discussion form message associated with the discussion forum thread and sending the converted discussion forum message to the discussion forum.

3. The method of claim 2, wherein the author of the new email may elect not to add the email to the discussion forum and the email is processed through the email server.

4. The method of claim 2, further comprising the step of copying replies on the discussion forum to emails and sending the emails to users who have sent or received messages in the email thread and who are not present on the discussion forum.

5. The method of claim 1, further comprising the steps of:
assigning a unique identifier to the discussion forum thread;
determining if there are email participants of the discussion forum; and
in response to a new discussion forum message in the converted thread copying said message as an email and sending the converted email to the email participants.

6. An apparatus for making a live connection between an email thread and a discussion forum thread, comprising:
An email server interconnected through a network with a plurality of user devices; and
A plug-in installed on the email server and configured to execute the steps of:
Receiving a nomination of a discussion forum to convert an email thread to the discussion forum;
Copying the emails in the email thread as a discussion forum topic with a set of replies comprising details from the emails; and
Sending the discussion forum topic with a set of replies to a discussion forum server.

7. The apparatus of claim 6, wherein the plug-in is configured to perform the steps of:
assigning a unique identifier to the discussion forum thread; and
in response to a new email reply in the converted thread copying said email reply as a discussion form message associated with the discussion forum thread and sending the converted discussion forum message to the discussion forum.

8. The apparatus of claim 7, wherein the plug-in is configured to allow an author of the new email to elect not to add the email to the discussion forum and the email is processed through the email server.

9. The apparatus of claim 7, wherein the plug-in is configured to perform the step of copying replies on the discussion forum to emails and sending the emails to users who have sent or received messages in the email thread and who are not present on the discussion forum.

10. The method of claim 6, further comprising a discussion forum plug-in configured to perform the steps of:
assigning a unique identifier to the discussion forum thread;
determining if there are email participants of the discussion forum; and
in response to a new discussion forum message in the converted thread copying said message as an email and sending the converted email to the email participants.

11. A program product comprising a computer-readable medium having encoded thereon computer-executable programs steps for making a live connection between an email thread and a discussion forum thread, comprising:
first program instructions for receiving a nomination of a discussion forum to convert an email thread to the discussion forum;
second program instructions for copying the emails in the email thread as a discussion forum topic with a set of replies comprising details from the emails; and
third program instructions for sending the discussion forum topic with a set of replies to a discussion forum server.

12. The program product of claim 11, further comprising:
fourth program instructions for assigning a unique identifier to the discussion forum thread; and
fifth program instructions in response to a new email reply in the converted thread copying said email reply as a discussion form message associated with the discussion forum thread and sending the converted discussion forum message to the discussion forum.

13. The program product of claim 12, further comprising:
sixth program instructions allowing an author of the new email to elect not to add the email to the discussion forum whereby the email is processed through the email server.

14. The program product of claim 12, further comprising:
seventh program instructions for copying replies on the discussion forum to emails and sending the emails to users who have sent or received messages in the email thread and who are not present on the discussion forum.

15. The program product of claim 11, further comprising:
eighth program instructions for assigning a unique identifier to the discussion forum thread;
ninth program instructions for determining if there are email participants of the discussion forum; and
tenth program instructions for copying said message as an email and sending the converted email to the email participants in response to a new discussion forum message in the converted thread.
